(19) United States
(12) Patent Application Publication
(10) Pub. No.: US 2010/0056702 A1
(43) Pub. Date: Mar. 4, 2010

(54) POWDER MIXTURES, PROCESSES FOR PREPARING SUCH MIXTURES, POWDER COATINGS USING SUCH MIXTURES AND METHODS OF COATING SUBSTRATES WITH SUCH MIXTURES

(75) Inventors: Michael Grahl, Leverkusen (DE); Hans-Josef Laas, Odenthal (DE); Jörg Büchner, Bergisch Gladbach (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/546,982

(22) Filed: Aug. 25, 2009

(30) Foreign Application Priority Data
Aug. 30, 2008 (DE) 102008045224.6

(51) Int. Cl. C08L 75/04; C08L 67/00; B05D 3/02

(52) U.S. Cl. 524/539; 525/453; 524/500; 525/440.01; 427/385.5

(57) ABSTRACT

Powder mixtures for powder coatings comprising: (A) a non-blocked, micronized, cycloaliphatic diisocyanate-derived polyisocyanate which is solid below 40° C. and liquid above 120° C. and has an average particle size d₅₀ of below 10 μm; (B) a pulverulent binder component having an average particle size d₅₀ of below 100 μm, comprising 25 to 75 wt. % of at least one amorphous polyol (B1) and 75 to 25 wt. % of at least one crystalline or semicrystalline polyol (B2); and, (C) optionally, one or more powder coating auxiliary substances and additives; processes for preparing such mixtures; powder coating obtained therefrom and substrates coated therewith.

### BACKGROUND OF THE INVENTION

Under the pressure of increasingly more stringent environmental legislation, the development of powder coatings has gained increasing importance alongside high-solids lacquers and aqueous coating systems in recent years. Powder coatings release no solvents at all during application, can be processed with a very high utilization of material, and are therefore particularly environment-friendly and economical.

Light- and weather-resistant coatings of particularly high quality can be produced with hot curing powder coatings based on polyurethane. The polyurethane (PU) powder coatings currently established on the market in general comprise solid polyester polyols, which are cured with solid aliphatic or cycloaliphatic polyisocyanates, in general in blocked form.

For various uses, for example for coating office furniture, electrical and electronic equipment or for purely decorative coatings, there is a great interest in powder coatings which result in matte surfaces on curing, Shiny, highly reflecting lacquer systems are also often undesirable for coating façade parts. There has therefore been no lack of attempts to develop PU-based matte finish powder coatings.

The co-use of finely divided mineral or polymeric matting agents, a common method for establishing lower degrees of gloss in wet lacquers, in general does not lead to the desired success in powder coating systems.

Polyurethane powder coatings which cure reliably and reproducibly to give matte coatings are obtained, for example according to the teaching of German Patent Pub. No. DE 3338129 A, from polyester polyols in combination with pyromellitic dianhydride and ε-caprolactam-blocked polyisocyanates based on 1-isocyanato-3,3,5-trimethyl-5-isocyanatomethylcyclohexane (isophorone-diisocyanate; IPDI) as the crosslinker component.

Matte powder coatings also result if hydroxy-polyesters are crosslinked with specific ε-caprolactam-blocked derivatives of trans-1,4-diisocyanatocyclohexane having a melting range above 140° C., such as are described in German Patent Pub. No. DE 3711374A, or with ε-caprolactam-blocked polyisocyanates containing urea groups, such as can be obtained in accordance with the teaching of German Patent Pub. No. DE3739479A by reaction of partly blocked diisocyanates with di- or polyamines.

The use of combinations of specific blocked polyisocyanates containing carboxyl groups and polyepoxide crosslinking agents, such as e.g. triglycidyl isocyanurate (TGIC), as the curing agent component for pulverulent hydroxy-functional binders is the subject matter of German Patent Pub. No. DE 3232463 A. After stoving, these “3-component” powder coating systems give coatings of high weather resistance with matte effects which can be established reproducibly.

The PU powder coatings of the prior publications mentioned indeed all cure to give matte surfaces, but they have in common the main disadvantage that they contain as crosslinker components blocked polyisocyanates which release the blocking agent as a so-called elimination product during the stoving operation and emit it into the environment. During their processing, for ecological and industrial hygiene reasons particular precautionary measures must therefore be taken to purify the waste air and/or recover the blocking agent.

An attempt to bypass this main disadvantage of blocked polyisocyanates is to be seen in the use of linear IPDI powder coating curing agents which contain uretdione groups and are free from blocking agents, with which crosslinking takes place with thermal re-splitting of the uretdione groups. Attempts have also already been made to employ such uretdione powder coating curing agents which are free from elimination products for the production of matte coatings.

German Patent Pub. No. DE 3328133A describes, for example, polyaddition compounds based on an IPDI uretdione having melting points above 130° C., preferably above 140° C., which cure in combination with polyester polyols to give matte films.

According to the teaching of European Patent Pub. No. EP 0553750 A, powder coatings comprising a mixture of two hydroxy-polyesters of different OH number and reactivity and commercially available uretdione powder coating crosslinking agents based on IPDI which are free from elimination products likewise give matte coatings.

As “internally blocked” polyisocyanates, uretdione powder coating crosslinking agents thus indeed allow formulation of emission-free matte finish powder coatings, but like the powder coatings containing blocked polyisocyanates described above, these require temperatures of at least 140° C., as a rule even of at least 160° C., for their curing.

Non-blocked polyisocyanates, i.e., those having free isocyanate groups, have likewise already been proposed in the past as crosslinking agents for polyurethane powder coatings.

For example, European Patent Pub. Nos. EP 0193828A, EP0224165A and EP0254152A, the entire contents of each of which are hereby incorporated by reference herein, describe polyisocyanates which contain isocyanurate and/or urethane groups and have free isocyanate groups bonded to tertiary (cyclo)aliphatic carbon atoms and are solid at room temperature as crosslinker components for PU powder coatings. The slowness of the isocyanate groups bonded in tertiary form to react indeed on the one hand makes it possible for these specific polyisocyanates to be mixed in the non-blocked form with conventional hydroxy-functional powder coating binders at temperatures above their melting point without an undesirable preliminary reaction occurring, but on the other hand the low reactivity also means that for complete curing of the powder coatings formulated in this way, comparatively high stoving temperatures of at least 150° C., as a rule even at least 170° C., are required.

According to the teaching of European Patent Pub. No. EP0669351B, the entire contents of which are hereby incorporated by reference herein, completely “normal” branched, solid polyisocyanates with non-blocked isocyanate groups bonded to primary and/or secondary carbon atoms can also be used as powder coating crosslinking agents if specific polyols which contain hydroxyl groups which are bonded to secondary and/or tertiary carbon atoms and are predominantly sterically hindered and are therefore retarded in their reactivity are employed as reaction partners. The PU powder coating systems described in European Patent Pub. No. EP0780416A, the entire contents of which are hereby incorporated by reference herein, are also based on the principle of combination of solid non-blocked polyisocyanates with “slow” powder coating binders which carry hydroxyl groups bonded in secondary form. Nevertheless, neither the powder coatings according to EP0669351B nor those according to EP0780416A are true low temperature crosslinking systems. In both cases coatings which are resistant to solvents and chemicals are obtained only at temperatures from above 140° C., and these moreover have a high gloss. Matte coatings cannot be produced by these processes.

In addition, neither the PU powder coatings described above which are based on “slow” polyisocyanates with isocyanate groups bonded in tertiary form nor those based on “retarded” polyols with hydroxyl groups bonded predominantly in secondary and/or tertiary form have a storage stability which is adequate in practice. A creeping urethanization reaction is already to be observed at room temperature, leading to premature crosslinking and lump formation in the coating powders. In contrast to the powder coatings according to the invention described in more detail in the following, which in spite of a high content of free isocyanate groups are completely storage-stable even at elevated temperature, the PU powder coatings known hitherto which are formulated using non-blocked polyisocyanates must as a rule be stored with cooling, for example at temperatures of below 10° C.

### BRIEF SUMMARY OF THE INVENTION

The present invention provides novel PU powder coatings which are free from elimination products and which cure at significantly lower stoving temperatures than the powder coating systems known hitherto to give coatings of low degrees of gloss which are resistant to solvents and chemicals.

The present invention can provide such improved powder coatings by, and further includes, the powder mixtures described in more detail below, which comprise non-blocked cycloaliphatic polyisocyanates in micronized form in combination with specific pulverulent mixtures of hydroxy-functional binder components, the individual components of which are known per se.

Various embodiments of the present invention include powder mixtures for providing powder coatings, which mixtures comprise:

(A) a non-blocked micronized polyisocyanate based on cycloaliphatic diisocyanates which is solid below 40° C. and liquid above 120° C. and has an average particle size d₅₀ of below 10 μm,

(B) a pulverulent binder component having an average particle size d₅₀ of below 100 μm, comprising at least one amorphous polyol B1) to the extent of 25 to 75 wt. % and at least one crystalline or semicrystalline polyol B2) to the extent of 75 to 25 wt. %, and optionally

(C) further auxiliary substances and additives known from powder coating technology.

One embodiment of the present invention includes a powder mixture for powder coatings, the powder mixture comprising:
(A) a non-blocked, micronized, cycloaliphatic diisocyanate-derived polyisocyanate which is solid below 40° C. and liquid above 120° C. and has an average particle size d₅₀ of below 10 μm;
(B) a pulverulent binder component having an average particle size d₅₀ of below 100 μm, comprising 25 to 75 wt. % of at least one amorphous polyol (B1) and 75 to 25 wt. % of at least one crystalline or semicrystalline polyol (B2); and,

(C) optionally, one or more powder coating auxiliary substances and additives

Various embodiments of the present invention include processes for the preparation of these powder coating mixtures, which is characterized in that
(A) a non-blocked micronized polyisocyanate based on cycloaliphatic diisocyanates which is solid below 40° C. and liquid above 120° C. and has an average particle size d₅₀ of below 10 μm is mixed with
(B) a pulverulent hydroxy-functional binder component which has been obtained by mixing and joint homogenization of at least one amorphous polyol B1) with at least one crystalline or semicrystalline polyol B2) in a weight ratio of B1) to B2) of from 25:75 to 75:25, optionally co-using further auxiliary substances and additives C) known from powder coating technology, and subsequent grinding of the homogeneous mixture to an average particle size d₅₀ of below 100 μm,

in the dry state at a temperature of from 20 to 70° C., the mixture is subsequently optionally compressed and/or compacted at a temperature of from 20 to 80° C., and the mass optionally obtained in this way is ground again to give a powder having an average particle size d₅₀ of below 100 μm.

One embodiment of the present invention includes a process for preparing a powder mixture according to claim 1, the process comprising: (a) mixing the polyisocyanate (A) with the pulverulent binder component (B) in a dry state at a temperature of from 20 to 70° C.;

wherein the pulverulent binder component (B) is prepared by a process comprising mixing and joint homogenization of the at least one amorphous polyol (B1) with the at least one crystalline or semicrystalline polyol (B2) in a weight ratio of (B1) to (B2) of from 25:75 to 75:25, optionally along with the one or more powder coating auxiliary substances and additives (C), and subsequently grinding the homogenous mixture to an average particle size d₅₀ of below 100 μm.

Various embodiments of the present invention also include the use of the powder mixtures described herein for coating any desired heat-resistant substrates using powder coating technology.

### DETAILED DESCRIPTION OF THE INVENTION

As used herein, the singular terms “a” and “the” are synonymous and used interchangeably with “one or more” and “at least one,” unless the language and/or context clearly indicates otherwise, Accordingly, for example, reference to “a polyisocyanate” herein or in the appended claims can refer to a single polyisocyanate or more than one polyisocyanate. Additionally, all numerical values, unless otherwise specifically noted, are understood to be modified by the word “about.”

The powder mixtures according to the invention, and coatings obtained therefrom, comprise a low-monomer polyisocyanate component A) based on a cycloaliphatic diisocyanate(s) which is(are) solid below 40° C. and liquid above 120° C. and is in micronized form, i.e. has an average particle size d₅₀ of below 10 μm.

This polyisocyanate component A) comprises, for example, the polyisocyanates known per se which contain allophanate, biuret, isocyanurate, uretdione and/or urethane groups and are based on cycloaliphatic diisocyanates, with a content of free isocyanate groups of from 5 to 23, preferably 12 to 18 wt. %, an average NCO functionality of at least 2.1, preferably at least 2.4, particularly preferably at least 3.0, and a content of monomeric diisocyanates of less than 0.5 wt. %, preferably not more than 0.3 wt. %, which have in particular a melting point or melting range, determined by differential thermoanalysis (DTA), which lies within a temperature range of from 40 to 110° C., particularly preferably within the temperature range of from 50 to 100° C.

Suitable starting diisocyanates for the preparation of the polyisocyanates A) are any desired cycloaliphatic diisocyanates, such as e.g. 1-isocyanato-3,3,5-trimethyl-5-isocyanatomethylcyclohexane (isophorone-diisocyanate; IPDI), 2,4′- and 4,4′-diisocyanatodicyclohexylmethane, 1,3- and 1,4-diisocyanatocyclohexane, 2(4)-methyl-1,3-diisocyanatocyclohexane, 1,3- and 1,4-diisocyanatomethylcyclohexane, 1-isocyanato-1-methyl-4(3)-isocyanatomethylcyclohexane and any desired mixtures of these diisocyanates.

The polyisocyanate component A) preferably comprises polyisocyanates of IPDI, 2,4′- and/or 4,4′-diisocyanatodicyclohexylmethane containing isocyanurate groups, very particularly preferably a polyisocyanurate of IPDI having an isocyanate group content of from 15 to 18 wt. %.

The polyisocyanate component A) can optionally also contain minor amounts of low-monomer linearly aliphatic polyisocyanates, in particular those based on hexamethylene-diisocyanate (HDI), or also mixed polyisocyanates prepared from mixtures of the cycloaliphatic diisocyanates mentioned with linearly aliphatic diisocyanates, such as e.g. HDI. Nevertheless, the content of linearly aliphatic structures incorporated into A) must be kept as low as possible so that the above requirements with respect to melting point or melting range can be met. i.e. it should be not more than 20 wt. %, preferably not more than 15 wt. %, particularly preferably not more than 10 wt. %, based on the total weight of the polyisocyanate component A).

The preparation of the solid polyisocyanate component A) is known per se and is carried out, for example, by the processes described in Laas et al., J. PRAKT. CHEM. 336, 1994, pp. 185-200, the entire contents of which are incorporated herein by reference. Suitable processes are, in particular, catalytic oligomerization with the formation of isocyanurate and/or uretdione structures, reaction with so-called biuretizing agents, such as e.g. water, to give biurets and modification with alcohols to give urethanes and/or allophanates.

Processes for the preparation of the particularly suitable polyisocyanates containing isocyanurate groups are to be found described, for example, in EP-A-0 003 765, EP-A-0 010 589, EP-A-0 017 998, EP-A-0 047 452, EP-A-0 187 105, EP-A-0 197 864 and EP-A-0 330 966, the entire contents of each of which are incorporated herein by reference.

After their preparation by catalytic oligomerization and/or modification of cycloaliphatic diisocyanates and subsequent removal of the unreacted excess monomeric diisocyanates, for example by extraction or preferably by thin film distillation under a high vacuum, the low-monomer polyisocyanates obtained as a solid are finally ground with the aid of suitable grinding processes, e.g. in ball mills, bead mills, sand mills, disk mills or jet mills, to an average particle size d₅₀ of below 10 μm, preferably of below 5 μm, particularly preferably of below 2 μm.

The powder mixtures, and powder coatings obtained therefrom, according to the invention comprise as component B) a pulverulent hydroxy-functional binder component which is in solid form below 40° C. and in liquid form above 130° C. and comprises at least one amorphous polyol B1) and at least one crystalline or semicrystalline polyol B2).

These polyols B1) and B2) are any desired binders known from powder coating technology which contain hydroxyl groups and have an OH number of from 15 to 200 mg of KOH/g, preferably from 25 to 150 mg of KOH/g, and an average molecular weight (which can be calculated from the functionality and the hydroxyl content) of from 400 to 10,000, preferably from 1,000 to 5,000.

Suitable amorphous polyols B1) are, for example, hydroxy-functional polyesters, polyacrylates or polyurethanes, such as are described e.g. by way of example as powder coating binders in EP-A 0045998, EP-A 0 254 152 or WO 91/07452 on page 8, line 3 to 29, which can also be employed in any desired mixture with one another.

The polyol component B1) preferably comprises polyesters of the type mentioned containing hydroxyl groups or any desired mixtures of such polyester polyols which have softening temperatures (™) which—determined by differential thermoanalysis (DTA)—lie within the temperature range of from 40 to 120° C., particularly preferably within the temperature range of from 45 to 110° C.

Suitable crystalline or semicrystalline polyols B2) are, in particular, polyester polyols such as are described, for example, in WO 91/07452 from page 8, line 30 to page 11, line 25 or WO 2005/105879 from page 11, line 6 to page 12, line 7 or any desired mixtures of such polyester polyols. These crystalline or semicrystalline polyester polyols B2) preferably have melting points (according to DTA) in the range of from 30 to 130° C., particularly preferably in the range of from 40 to 100° C.

The auxiliary substances and additives C) optionally to be co-used are, for example, flow agents, such as e.g. polybutyl acrylate or those based on polysilicones, light stabilizers, such as e.g. sterically hindered amines, UV absorbers, such as e.g. benzotriazoles or benzophenones, pigments, such as e.g. titanium dioxide, or also colour stabilizers against the risk of yellowing caused by overstoving, such as e.g. trialkyl and/or triaryl phosphites optionally containing inert substituents, such as triethyl phosphite, triisodecyl phosphite, triphenyl phosphite or trisnonylphenyl phosphite. The auxiliary substances and additives are as a rule admixed to the binder component A).

For the preparation of the hydroxy-functional binder component B), at least one amorphous polyol B1) of the type mentioned is combined with at least one crystalline or semicrystalline polyol B2) of the type mentioned in a weight ratio of B1) to B2) of from 25:75 to 75:25, preferably from 30:70 to 70:30, and optionally further auxiliary substances and additives C) known from powder coating technology, for example on extruders or kneaders at temperatures above the melting range of the individual components, for example at 80 to 140° C., preferably at 80 to 120° C., to form a homogeneous material. The solid resulting after cooling of the melt is then ground to an average particle size d₅₀ of below 100 μm and freed from the grain contents above 0.1 mm by sieving.

For the preparation of the finished powder mixtures, the micronized polyisocyanate A) and the pulverulent binder component B) optionally containing further auxiliary substances and additives C) are mixed with one another in the dry state at a temperature of from 20 to 70° C. This can be carried out in commercially available mixing apparatuses which are known from powder coating technology and are suitable for homogenizing dryblend mixtures, for example in an MTI mixer type LM 5/3.5 from Mischtechnik Industrieanlagen GmbH (Detmold, Germany).

The powder obtained is subsequently optionally compressed and/or compacted at a temperature of from 20 to 8° C. under a pressure in the range of 10-300 bar, for example in commercially available roller compactors, e.g. those of the type RC from Powtec Maschinen und Engineering GmbH (Remscheid, Germany), and the mass which thereby results is ground a further time to give a powder having an average particle size d₅₀ of below 100 μm.

A further possibility for the preparation of the powder coating mixtures according to the invention is that of binding the micronized polyisocyanate A) to the pulverulent binder component B) optionally containing further auxiliary substances and additives C) in a commercially available bonding process (e.g. Blitz® Bonding, Benda-Lutz Werke GmbH, Austria), such as is conventionally used for the preparation of effect pigment powder coatings.

Regardless of the nature of the preparation, components A) and B) can be employed in the powder coating according to the invention in ratios of amounts such that 0.6 to 1.5, preferably 0.8 to 1.2 isocyanate groups of component A) are available for each hydroxyl group of component B).

The powder coating mixtures according to the invention prepared in this way are as a rule completely stable to storage at room temperature. They can be stored over a relatively long period of time, such as e.g. 3 months, without detectable changes, even at elevated temperature, e.g. at 40° C.

The powder mixtures according to the invention can be applied by conventional powder application processes, such as e.g. electrostatic powder spraying or fluidized bed sintering, to the substrates to be coated. Curing of the coatings is already achieved at significantly lower temperatures than are necessary for the polyurethane powder coatings known hitherto, for example by heating to temperatures of from 80 to 140° C., preferably 80 to 120° C., for example during a period of time of from approx. 10 to 30 minutes. Hard and elastic deep-matte coatings are obtained.

Powder coatings prepared with the aid of the polyisocyanate mixtures according to the invention have a high resistance to light and weather, and are therefore particularly suitable for external uses.

Any desired heat-resistant substrates, such as, for example, those of glass or metals, can be coated according to the invention. However, the exceptionally low stoving temperatures moreover also open up completely new fields of use, such as e.g. coating of plastics or wood substrates, for the polyurethane powder coatings according to the invention.

The invention will now be described in further detail with reference to the following non-limiting examples.

### EXAMPLES

Unless noted otherwise, all the percentage data relate to the weight.

The NCO contents were determined in accordance with DIN EN ISO 11909.

The gelling time, determined in accordance with DIN 55 990, part 8, point 5.1, is stated as a measure of the reactivity of the powder coating formulations.

To characterize the mechanical properties of the cured lacquer films, the Erichsen indentation was determined in accordance with DIN EN ISO 1520 and the reverse impact (ball impact test) was determined in accordance with ASTM D2794.

Degrees of gloss were measured in accordance with DIN 67530, in each case at an angle of reflection of 20° and 60°.

### Starting Compounds

Micronized Polyisocyanate (A I)

Isophorone-diisocyanate (IPDI) is trimerized in accordance with Example 2 of EP-A 0 003 765 to an NCO content of 31.1% and the excess IPDI is removed by thin film distillation at 170° C./0.1 mbar. An isocyanurate polyisocyanate is obtained as a virtually colourless solid resin with an NCO content of 16.4% and a content of monomeric IPDI of <0.2%.

This solid resin, which has a Tg of approx. 65° C., is ground to an average particle size d₅₀ of approx. 1.2 μm at 25° C. under dry nitrogen with the aid of a fluidized bed opposed jet mill type 400 TFG (Hosokawa Alpine AG, Augsburg).

Micronized Polyisocyanate A II)

10 g of a 10% strength solution of N,N,N-trimethyl-N-(2-hydroxypropyl)ammonium hydroxide (prepared by reaction of trimethylamine with propylene oxide in methanol, dissolved in 2-ethyl-1,3-hexanediol:1,3-butanediol=4:1) are added to 2,620 g of 4,4′-diisocyanatodicyclohexylmethane and trimerization is carried out at 75 to 80° C. to an NCO content of 26.8%. In a mixture with 15 parts by wt. of the isocyanurate polyisocyanate based on hexamethylene-diisocyanate (HDI) obtained in accordance with Example 12 of EP 330 966, 100 parts by wt. of a pale yellow solid resin with an NCO content of 15.1% and a content of monomeric diisocyanates of <0.2% are obtained after thin film distillation at 200° C./0.15 mbar.

This solid resin, which has a Tg of approx. 56° C., is ground to an average particle size d₅₀ of approx. 1.2 μm at 25° C. under dry nitrogen with the aid of a fluidized bed opposed jet mill type 400 TFG (Hosokawa Alpine AG, Augsburg).

Pulverulent, Non-Micronized Polyisocyanate (V I)

The IPDI trimer with an NCO content of 16.4% and a content of monomeric IPDI of <0.2% employed for the preparation of the micronized polyisocyanate A I) was ground and sieved with the aid of an air classifier mill ACM II (Hosokawa Mikropul) with a 90 μm screen.

Amorphous Polyster Polyol B1)

Polyester containing hydroxyl groups, prepared from 47.3 parts by wt. of terephthalic acid, 44.6 parts by wt. of neopentyl glycol, 2.9 parts by wt. of adipic acid and 5.2 parts by wt. of trimellitic anhydride.

| | |
|---|---|
| OH number: | 40 mg of KOH/g |
| Acid number: | 13 mg of KOH/g |
| Melting range (DTA): | 58 to 62° C. |

Crystalline Polyester Polyol B2)

Polyester containing hydroxyl groups, prepared from 65.1 parts by wt. of dodecanedioic acid and 34.9 parts by wt. of hexanediol.

| | |
|---|---|
| OH number: | 30 mg of KOH/g |
| Acid number: | 1 mg of KOH/g |
| Melting point (DTA): | approx. 40° C. |

### Example 1

### According to the Invention and Comparison

27.1 parts by wt. of the amorphous polyester polyol B1) were mixed thoroughly with 27.1 parts by wt. of the crystalline polyester polyol B2), corresponding to a weight ratio of B1) to B2) of 50:50, and, as auxiliary substances and additives C), with 1.5 parts by wt. of a commercially available flow agent (Resiflow® PV 88, Worlée-Chemie, Hamburg, Germany), 0.5 part by wt. of benzoin and 35.0 parts by wt. of a white pigment (Kronos® 2160, Kronos Titan, Leverkusen, Germany) and the mixture was then homogenized with the aid of a Buss co-kneader of the type PLK 46 at 150 rpm and a housing temperature of 40° C. in the intake region and at the shaft and of 80° C. in the process part, material temperatures of from 95 to 100° C. being achieved. The solidified melt was ground and sieved with the aid of an air classifier mill ACM II (Hosokawa Micropul) with a 90 μm screen.

The pulverulent binder component B) obtained in this way, which already contains auxiliary substances and additives C), was mixed with 8.8 parts by wt. of the micronized polyisocyanate A I), corresponding to an equivalent ratio of NCO to OH of 1:1, at 25° C. in an MTI mixer type LM 5/3.5 (Mischtechnik Industrieanlagen GmbH, Detmold, Germany), at 25° C. for 30 s at 2,000 rpm. A powder coating according to the invention with a gelling time of 56 s at 160° C. was obtained.

For comparison, a powder coating was prepared from 91.2 parts by wt. of the pulverulent binder component B) described above, containing auxiliary substances and additives C), and 8.8 parts by wt. of the pulverulent polyisocyanate component V I) in the same manner by dry mixing. The equivalent ratio of NCO to OH was 1:1, as in the powder coating according to the invention described above. A gelling time of 82 s at 160° C. was measured.

The two powder coatings obtained in this way were sprayed with an ESB bucket gun at a high voltage of 70 kV on to degreased steel sheets and were cured at a temperature of 100° C. for 15 min.

In the case of the powder coating according to the invention, a completely crosslinked, deep-matte coating with very good flow was obtained. At a layer thickness of approx. 60 μm, a degree of gloss (20°/60°) of 1.4/4.4 was measured. The reverse impact was 60 inch pounds.

In the case of the powder coating prepared using the pulverulent, non-micronized polyisocyanate V I), a rough, completely inhomogeneous and non-closed coating was obtained.

To check the storage stability, the powder coating according to the invention was stored at a temperature of 40° C. for 4 weeks. The gelling time of the powder, which continued to be free-flowing, was then 61 s at 160° C. A lacquer film cured at 100° C. for 15 min showed a practically unchanged profile of properties compared with the coating obtained from the freshly prepared, i.e. not stored, powder coating.

### Examples 2 to 5

### According to the Invention

### Examples 6 to 8

### Comparison

White-pigmented powder coatings were prepared by the process described in Example 1 starting from pulverulent binder components B) and micronized polyisocyanates A) as crosslinking agents, and were sprayed with an ESB bucket gun at a high voltage of 50 kV on to degreased steel sheets. The lacquers were then stoved in each case for 15 min at 120° C. The following table shows the compositions (parts by wt.) of the powder coatings and the technical lacquer data of the coatings obtained therefrom.

Matte coatings are obtained in all cases. However, the examples show that only powder coatings 2 to 5 according to the invention, in which the claimed ratio of amorphous polyol component B1) to crystalline or semicrystalline polyol component B2) is adhered to, cure to give completely crosslinked coatings with good optical and mechanical properties.

| | Example | | | | | | |
|---|---|---|---|---|---|---|---|
| | | | | | 6 | 7 | 8 |
| | 2 | 3 | 4 | 5 | (comparison) | (comparison) | (comparison) |
| Polyisocyanate A I) | — | 9.2 | 8.3 | 8.1 | 9.5 | 9.7 | 7.6 |
| Polyisocyanate A II) | 9.4 | — | — | — | — | — | — |
| Polyester polyol B1) | 26.8 | 40.3 | 18.0 | 13.7 | 48.1 | 53.3 | — |
| Polyester polyol B2) | 26.8 | 13.5 | 36.7 | 41.2 | 5.4 | — | 55.4 |
| Resiflow ® PV 88 | 1.5 | 1.5 | 1.5 | 1.5 | 1.5 | 1.5 | 1.5 |
| Benzoin | 0.5 | 0.5 | 0.5 | 0.5 | 0.5 | 0.5 | 0.5 |
| Kronos ® 2160 | 35.0 | 35.0 | 35.0 | 35.0 | 35.0 | 35.0 | 35.0 |
| B1):B2) | 50:50 | 75:25 | 67:33 | 25:75 | 90:10 | 100:0 | 0:100 |
| Equivalent ratio NCO:OH | 1:1 | 1:1 | 1:1 | 1:1 | 1:1 | 1:1 | 1:1 |
| Layer thickness [μm] | 72 | 67 | 81 | 82 | 55 | 73 | 85 |
| Erichsen indentation [mm] | >9.0 | >9.0 | 8.1 | 5.6 | 1.4 | <1.0 | <1.0 |
| Gloss (20°/60°) | 1.4/5.9 | 2.8/14 | 1.6/5.3 | 1.6/5.6 | 2.4/12 | 3.0/15 | 3.5/23 |
| Flow, visual | very good | very good | very good | good | good | poor | good |
| Acetone test | good | good | adequate | adequate | poor | poor | adequate |
| Gel time @ 160° C. [s] | 56 | 179 | 76 | 45 | 296 | 39 | >300 |
| Gel time @ 160° C. after | 64 | 185 | 82 | 54 | >300 | 47 | >300 |
| 4 weeks @ 40° C. [s] | | | | | | | |
| Flowability after | very good | very good | very good | very good | very good | very good | very good |
| 4 weeks @ 40° C. | | | | | | | |

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A powder mixture for powder coatings, the powder mixture comprising:
(A) a non-blocked, micronized, cycloaliphatic diisocyanate-derived polyisocyanate which is solid below 40° C. and liquid above 120° C. and has an average particle size d₅₀ of below 10 μm;
(B) a pulverulent binder component having an average particle size d₅₀ of below 100 μm, comprising 25 to 75 wt. % of at least one amorphous polyol (B1) and 75 to 25 wt. % of at least one crystalline or semicrystalline polyol (B2); and,
(C) optionally, one or more powder coating auxiliary substances and additives.

2. The powder mixture according to claim 1, wherein the polyisocyanate (A) is derived from one or more of isophorone-diisocyanate, 4,4′- and/or 4,2′-diisocyanatodicyclohexylmethane.

3. The powder mixture according to claim 1, wherein the polyisocyanate (A) comprises a polyisocyanurate based on isophorone-diisocyanate having an isocyanate group content of from 15 to 18 wt. %.

4. The powder mixture according to claim 1, wherein the polyisocyanate (A) has an average particle size d₅₀ of below 5 μm.

5. The powder mixture according to claim 1, wherein (B1) comprises at least one amorphous polyester polyol having a softening temperature (™) within the temperature range of from 40 to 120° C.

6. The powder mixture according to claim 1, wherein (B2) comprises at least one crystalline or semicrystalline polyester polyol having a melting point in the range of from 30 to 130° C.

7. The powder mixture according to claim 1, having an overall average particle size d₅₀ of below 100 μm.

8. A powder mixture for powder coatings, the powder mixture comprising:
(A) a non-blocked, micronized, polyisocyanate comprising a polyisocyanurate based on isophorone-diisocyanate having an isocyanate group content of from 15 to 18 wt. %, and which is solid below 40° C. and liquid above 120° C. and has an average particle size d₅₀ of below 5 μm;
(B) a pulverulent binder component having an average particle size d₅₀ of below 100 μm, comprising 25 to 75 wt. % of at least one amorphous polyol (B1) having a softening temperature (™) within the temperature range of from 40 to 120° C. and 75 to 25 wt. % of at least one crystalline or semicrystalline polyol (B2) having a melting point in the range of from 30 to 130° C.; and,
(C) optionally, one or more powder coating auxiliary substances and additives.

9. A process for preparing a powder mixture according to claim 1, the process comprising: (a) mixing the polyisocyanate (A) with the pulverulent binder component (B) in a dry state at a temperature of from 20 to 70° C.;
wherein the pulverulent binder component (B) is prepared by a process comprising mixing and joint homogenization of the at least one amorphous polyol (B1) with the at least one crystalline or semicrystalline polyol (B2) in a weight ratio of (B1) to (B2) of from 25:75 to 75:25, optionally along with the one or more powder coating auxiliary substances and additives (C), and subsequently grinding the homogenous mixture to an average particle size d₅₀ of below 100 μm.

10. The process according to claim 9, further comprising (b) compressing and/or compacting the mixture at a temperature of from 20 to 80° C. to provide a mass; and (c) grinding the mass thus obtained to provide a powder mixture having an average particle size d₅₀ of below 100 μm.

11. The process according to claim 9, wherein the polyisocyanate (A) and the pulverulent binder component (B) are mixed in an amount such that 0.6 to 1.5 isocyanate groups in (A) are available for each hydroxyl group of component (B).

12. The process according to claim 10, wherein the polyisocyanate (A) and the pulverulent binder component (B) are mixed in an amount such that 0.6 to 1.5 isocyanate groups in (A) are available for each hydroxyl group of component (B).

13. A process comprising:
(a) providing a substrate having a surface to be coated;
(b) providing a powder mixture according to claim 1; and
(c) powder coating the surface with the powder mixture.

14. A process comprising:
(a) providing a substrate having a surface to be coated;
(b) providing a powder mixture according to claim 8; and
(c) powder coating the surface with the powder mixture.

15. A substrate having at least one surface having a coating provided thereon by a process according to claim 13.

16. A substrate having at least one surface having a coating provided thereon by a process according to claim 14.
